(19) United States
(12) Patent Application Publication
(10) Pub. No.: US 2026/0330683 A1
(43) Pub. Date: Oct. 22, 2026

(54) APPARATUS AND METHODS OF MONITORING A LOCATION OF AN OBJECT

(71) Applicant: PRISM DATUM LTD, Pontypridd (GB)

(72) Inventors: Paul Stidworthy, Pontypridd (GB); Christopher White, Pontypridd (GB)

(21) Appl. No.: 19/693,489

(22) Filed: May 31, 2026

Related U.S. Application Data
(63) Continuation of application No. PCT/GB2024/052981, filed on Nov. 27, 2024.

(30) Foreign Application Priority Data
Nov. 30, 2023 (GB) 2318330.4

(51) Int. Cl. G06T 7/73; G01C 11/02

(52) U.S. Cl. CPC G06T 7/75; G01C 11/02; G06T 2207/10028

(57) ABSTRACT

Automated total stations take regular measurements of targets that have been placed at various locations on a site to enable automated tracking of the objects to which they are connected. A sensor is configured to determine movement of a remote device and a transmitter is configured to send a signal in response to the movement of the remote device to activate an automated total station. In this way, even though any movement of the remote device detected by the sensor may not be sufficiently accurate/precise to be used to update a stored location of the remote device, such detected movement may be used to trigger a measurement by the automated total station, thereby ensuring that tracking of remote devices is performed in real-time, whilst avoiding unnecessarily frequent measurement of all targets on the site.

### RELATED APPLICATIONS

This application claims the benefit under 35 U.S.C. § 120, and is a continuation, of co-pending International Application PCT/GB2024/052981, filed Nov. 27, 2024 and designating the US, which claims priority to GB Application 2318330.4, filed Nov. 30, 2023, such GB Applications also being claimed priority to under 35 U.S.C. § 119. These GB and International applications are incorporated by reference herein in their entireties.

### FIELD

The present invention relates generally to apparatus and methods of monitoring a location of an object and finds particular, although not exclusive, utility with surveying equipment such as automated total stations, 3D laser scanners and Photogrammetry systems.

### BACKGROUND

Total stations and 3D laser scanners are electronic optical instruments used for surveying, typically in mining and construction but also in other fields. Total stations typically comprise a theodolite integrated with an electronic distance measurement device to measure both vertical and horizontal angles and the slope distance from the total station to a particular point, and a processor to collect data and perform triangulation calculations. 3D laser scanners typically comprise a time-of-flight laser range finder (LiDAR) to measure the distance to a point. The laser range finder is moved directly or the laser pulse directed using mirrors in order to scan multiple points in a scene, producing a 3D point cloud. Photogrammetry systems typically take photos from many different viewpoints which are digitally processed to calculate depth and produce a 3D point cloud. Conventionally, total stations are used in combination with remotely-positioned retroreflectors or prisms (termed ‘targets’) to form a surveying system in which the total station is used to determine the relative locations in 3D space of each such target. 3D laser scanners and photogrammetry systems may be used with optically recognisable targets, such as patterns with reflective and non-reflective surfaces.

Automated total stations can be controlled to take regular measurements of such targets that have been placed at various locations on a site, such as on buildings and equipment, to enable automated tracking of those targets, and hence the objects to which they are connected. In particular, this enables events such as subsidence to be monitored. Likewise, 3D laser scanners and photogrammetry systems can be controlled to take regular scans of the environment. The resulting 3D point clouds can be compared, and using digital processing and object recognition, any movement can be identified.

### SUMMARY

Although surveying equipment can be mains-powered, due to the nature of the environments in which they are used, such equipment is often battery powered. In any event, there is a balance to be struck between ensuring up-to-date measurements are available (requiring frequent scanning or measuring of all targets on the site) and avoiding excessive power consumption (requiring less frequent scanning or measuring of all targets on the site). In particular, full sweeps of the site by total stations are highly energy intensive and time consuming, and so real-time tracking of targets is not feasible in practice. Likewise, 3D scanning using laser scanners or photogrammetry is energy intensive but also requires significant resources to transfer and process the resulting point clouds.

According to a first aspect of the present invention, there is provided a remote device for use with a piece of surveying equipment, the remote device comprising: a sensor configured to determine a movement of the remote device; and a transmitter configured to send a signal, in response to the movement of the remote device, to activate a piece of surveying equipment.

In this way, even though any movement of the remote device detected by the sensor may not be sufficiently accurate/precise to be used to update a stored location of the remote device, such detected movement may be used to trigger a measurement of the target or targets associated with the device by the automated total station, thereby ensuring that tracking of remote devices in 3D space is performed in real-time, whilst avoiding unnecessarily frequent measurement of all targets on the site. Similarly, the detected movement may be used to trigger measurement by a 3D laser scanner, or to trigger measurement by a photogrammetry system. Furthermore, the 3D laser scanner or photogrammetry system may be directed to scan just the area proximal to the remote device, thus significantly reducing the amount of data captured, and processed.

The sensor may comprise an accelerometer, a gyroscope, a geophone (or alternative sensor configured to measure vibration), a Satellite Navigation Systems (optionally with a differential correction source, which could be co-located with the remote device, the base station or spaced therefrom), a time-of-flight sensor (e.g. using radio or infrared/optical, and/or between the remote device and the base station), a received signal strength indicator (e.g. between the remote device and the base station) and/or any combination of these or other appropriate sensors.

The remote device may comprise a plurality of such sensors, for example a plurality of one of the types mentioned above, and or a plurality of a single type (e.g. such that measurements can be taken along multiple non-parallel axes, such as in two or three dimensions). However, in some embodiments, only a single sensor (or only a single sensor of a specific type) may be included in the remote device (such that measurements can be taken in only one direction).

The sensor(s) may detect acceleration, e.g. by detecting vibration and shock, and/or may detect angular velocity.

Such sensors may be very low power, and can monitor movements over timescales of many months or years on battery power alone (such remote device incorporating a battery), or indefinitely if the remote device incorporates a renewable power source such as a solar PV cell.

The remote device may comprise a processor configured to analyse movement data acquired by the sensor. For instance, the sensor may comprise the processor, or the processor may be distinct from the sensor. In alternative arrangements, movement data is not processed at the remote device, but could be sent by the transmitter in the signal, for processing external to the remote device.

The movement data may be analysed (e.g. using digital signal processing or otherwise) to estimate amplitude and/or frequency or vibration, a velocity of movement and/or a displacement, and may optionally determine a confidence in said estimate (e.g. a likelihood of movement and/or a magnitude of movement).

The transmitter may be configured to send the signal in response to a likelihood of movement and/or a magnitude of movement exceeding a predefined threshold. For example, if the inclination (in any axis) of a structure to which the remote device is attached exceeds a certain threshold, if said structure is subject to vibrations exceeding a threshold that could indicate that movement is a risk, and/or if the likelihood of movement and/or the magnitude of movement exceeds a threshold.

The transmitter may send the signal over a long-and/or short-range radio mesh system, long-and/or short-range point-to-point radio system, cellular connection to the internet, a physical communications cable (e.g. forming direct point-to-point communication or via the Internet).

The signal may contain information about the remote device, including a unique identifier (e.g. a MAC address or other assigned tag), the nature of the detected movement (e.g. impact, inclination, vibration, etc., likelihood of movement and/or magnitude of movement), and/or a time of the movement.

The piece of surveying equipment may comprise an automated total station, a 3D laser scanner, and/or a photogrammetry system.

3D laser scanners use LIDAR technology to create a 3D point cloud model of an environment, and operate by a similar principle to automated total stations, but do not require the use of retroreflector targets. Accordingly, the data acquired can be significantly greater than that acquired by automated total stations, and the benefits of the present invention when applied to 3D laser scanners equally as great.

Photogrammetry is a method that uses photographic images (and optionally other data) to generate corresponding 3D point cloud models similar to those created by 3D laser scanning.

The present invention enables updating of these point cloud models in real-time, whilst avoiding unnecessarily frequent measurement to take place.

The remote device may further comprise a target that can be used by the piece of surveying equipment, when activated, to determine a location in 3D space of the target.

The target may be configured to reflect a beam of light from the piece of surveying equipment, when activated, back toward the automated total station.

Alternatively or additionally, the target may be configured to reflect a beam of light from an automated total station back toward the automated total station, or a target comprising a pattern that can be recognised by the surveying equipment, when activated, in a 3D point Cloud.

In this way, an accurate location of the remote device can be determined by an automated tool station by reflecting a beam of light from the target, or from processing of 3D point cloud data acquired by a 3D laser scanner or photogrammetry system. The remote device may be a single unit physically containing the sensor, transmitter and target (and any other component parts thereof). However, it is conceivable that one or more of said component parts may be physically spaced from the others and/or separate therefrom. For example, the sensor and transmitter may be spaced from the target; that is, an adjunct unit may comprise the sensor and transmitter, and both the adjunct unit and the target may be attached to the same structure or item of machinery (so that movement of one results in movement of the other), but they may be physically separate components that do not need to communicate with one another.

The remote device may be formed by retro-fitting an adjunct device to an existing and/or off-the-shelf target. For example, the remote device may comprise a housing in which the existing target may be housed. Alternatively or additionally, the adjunct unit may be connected to the existing target.

According to a second aspect of the present invention, there is provided a surveying system for monitoring a location of an object, the surveying system comprising: the remote device according to the first aspect; and a base station comprising: a receiver for receiving the signal from the transmitter; and a controller configured to activate a piece of surveying equipment in response to receiving the signal.

In some arrangements, movement data acquired by the sensor may be sent to the base station in the signal, and the base station may comprise a processor configured to analyse movement data acquired by the sensor, as discussed above.

The surveying system may further comprise a piece of surveying equipment.

The base station may be co-located with the piece of surveying equipment, form part of the piece of surveying equipment, or be spatially separate from the piece of surveying equipment.

The controller may activate the piece of surveying equipment by sending commands to a control unit of the piece of surveying equipment via the internet, using the piece of surveying equipment's internet platform.

The controller may communicate directly with a control unit of the piece of surveying equipment, in order to activate the piece of surveying equipment.

The base station may activate the piece of surveying equipment by commanding it to measure the environment around the remote device (which could include the entire environment available to the piece of surveying equipment where necessary, or just a region in the vicinity of the remote device). For example, the base station may activate the automated total station by commanding it to measure the target in order to acquire a precise location in 3D space thereof. Alternatively or additionally, the base station may activate the 3D laser scanner and/or photogrammetry device to update their 3D point cloud model, or a portion thereof.

The piece of surveying equipment may be configured to project a beam of light therefrom in response to being activated by the controller.

The base station and/or the piece of surveying equipment may maintain a database of locations of targets, and/or a database of locations of remote devices, as appropriate. When activated by the controller, the piece of surveying equipment may use a location of the target and/or remote device from the database, optionally combined with movement data from the sensor(s), to measure that target and/or the region around the remote device.

In this way, because the piece of surveying equipment only measures specific targets and/or regions when necessary, power and time is saved, and real-time recording is achieved.

The piece of surveying equipment may update the database with a new location, once acquired. The database may maintain a history of target geometry and/or the 3D point cloud model, such that any trends can be monitored and analysed. The piece of surveying equipment may then issue an alert/report to indicate movement (e.g. of a target, remote unit or structure), when necessary. Such a report may also include the movement data.

The surveying system may comprise a plurality of remote devices according to the first aspect.

In this way, for example, a time-of-flight sensor and/or a received signal strength indicator could be used between the remote devices.

The sensors could determine movement relative to each other (e.g. relative to another sensor, or relative to another remote device).

The piece of surveying equipment may further comprise an automated total station, a 3D laser scanner, and/or a photogrammetry system.

The automated total station may be configured to identify a target that has been targeted. That is, when the automated total station receives a reflected beam from a target, the automated total station may be configured to identify the target, for example to confirm that the target from which the reflected beam originates is the target associated with the remote device in question.

For example, automated total station may comprise a camera for viewing a visual identifier associated with the target. The visual identifier may be a number, bar code, QR code, etc.

The visual identifier may comprise a light emitting device (e.g. an LED, which may be in visible and/or infrared light), which may pulse in a unique sequence/code. The light emitting device may be configured to pulse in the unique sequence/code in response to a prompt from the automated total station and/or remote device.

Alternatively or additionally, an operator may be required to enter a device identifier when relative location readings are acquired by the automated total station.

The automated total station may the record the relative location of a target together with its associated identifier.

Additional non-sensor-equipped targets may optionally be installed close to each device. The geometry of these additional targets may be recorded along with the target associated with the remote device.

The positions of any such non-sensor-equipped targets may also be recorded and stored in the database.

According to a third aspect of the present invention, there is provided an adjunct unit for use with a target to form a remote device, the remote device for use with an automated total station, the remote device comprising: a sensor configured to determine a movement of the remote device; and a transmitter configured to send a signal, in response to the movement of the remote device, to activate an automated total station.

According to a fourth aspect of the present invention, there is provided a method of monitoring a location of an object, the method comprising the steps of: providing the surveying system according to the second aspect; the sensor determining a movement of the remote device; the transmitter sending a signal, in response to the movement of the remote device, to the base station; the receiver receiving the signal from the transmitter; the controller activating the piece of surveying equipment in response to receiving the signal; and the piece of surveying equipment determining a location of the remote device.

Determining a location of the remote device may comprise the piece of surveying equipment projecting a beam therefrom.

In some arrangements, the piece of surveying equipment may comprise an automated total station, and the method may further comprise the step of the target reflecting the beam of light back toward the automated total station. In alternative arrangements, the piece of surveying equipment may comprise a 3D laser scanner, and the step of determining the location of the remote device comprises processing 3D point cloud data acquired by the 3D laser scanner.

Alternatively, the piece of surveying equipment may comprise a photogrammetry system, and the step of determining the location of the remote device may comprise processing 3D point cloud data acquired by the photogrammetry system.

In some arrangements, regular measurement may be carried out routinely in order to detect any movements that have not been identified by remote units, for example if the movement is too gradual to be detected by the sensor.

### BRIEF DESCRIPTION OF THE ACCOMPANYING DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is schematic representation of a first surveying system.

FIG. 2 is schematic representation of a second surveying system.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B”should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

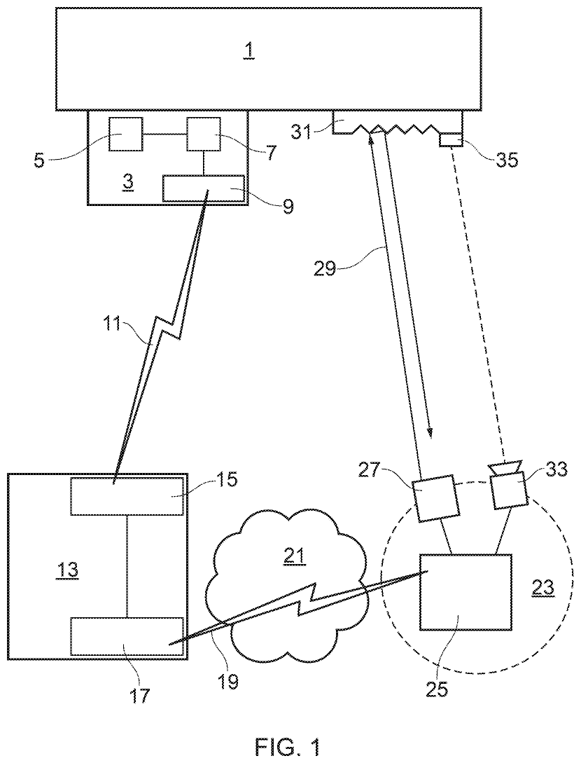

FIG. 1 is schematic representation of a first surveying system for monitoring a location of an object 1. Attached to the object 1 is an adjunct unit 3 comprises a sensor 5 configured to determine a movement, a processor 7 configured to analyse movement data acquired by the sensor to determine whether a likelihood of movement and/or a magnitude of movement exceeds a predefined threshold, and a transmitter 9 configured to send a signal 11 in response thereto.

The signal 11 is received by a receiver 15, forming part of a base station 13. In response thereto, a controller 17 configured to send a command 19, over the internet 21, to an automated total station 23.

The automated total station 23 receives the command 19 in its control unit 25, causing the automated total station 23 to projecting a beam of light 29 from a laser rangefinder 27 toward a target 31.

The target 31 reflects the beam of light back toward the automated total station for precise measurement of range and direction.

Simultaneously, a camera 33 on the automated total station 23 reads a visual indication 35 on the target 31, so that the automated total station 23 can confirm that the measured range and direction of the target corresponds to the adjunct unit 3 associated therewith.

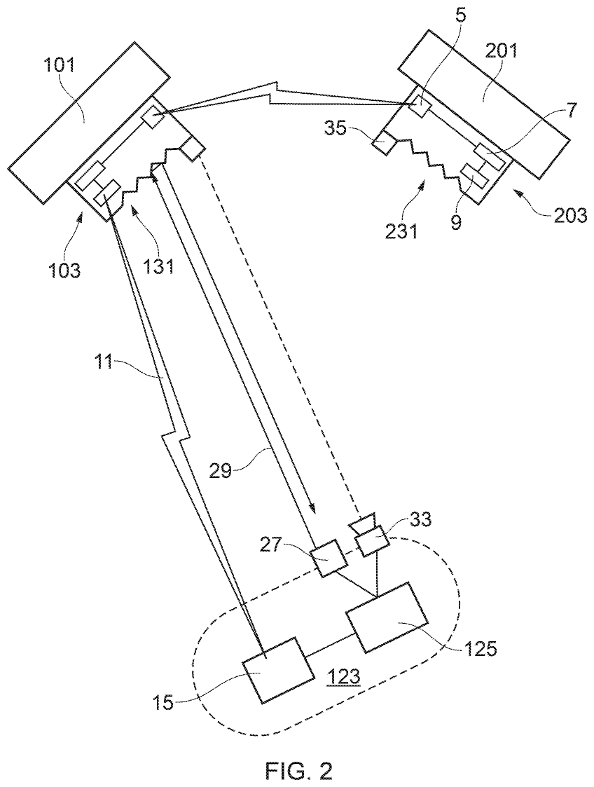

FIG. 2 is schematic representation of a second surveying system for monitoring a location of a first object 101 and a second object 201. Attached to each object 101,102 is a respective remote device 103,203, each comprising a sensor 5 configured to determine a movement, a processor 7 configured to analyse movement data acquired by the sensor to determine whether a likelihood of movement and/or a magnitude of movement exceeds a predefined threshold, and a transmitter 9 configured to send a signal 11 in response thereto. In addition, the first remote device 103 includes a first target 131, and the second remote device 203 includes a second target 231. Each target 131,231 is provided with a respective and unique visual indication 35.

The sensors 5 are configured to communicate with each other, to determine a relative distance therebetween. In this way, movement of one object 101,201 is detected by the sensors 5 and causes the signal 11 to be sent.

The signal 11 is received by a receiver 15, forming part of an automated total station 123. In response thereto, a controller 125 commands the automated total station 123 to projecting a beam of light 29 from a laser rangefinder 27 toward the first target 131.

The first target 131 reflects the beam of light back toward the automated total station 123 for precise measurement of range and direction.

Simultaneously, a camera 33 on the automated total station 123 reads the visual indication 35 on the first target 131, so that the automated total station 123 can confirm that the measured range and direction of the target corresponds to the remote unit 103 associated therewith.

1. A remote device for use with a piece of surveying equipment, the remote device comprising:
a sensor configured to determine a movement of the remote device; and
a transmitter configured to send a signal, in response to the movement of the remote device, to activate a piece of surveying equipment; and
a target that can be used by the piece of surveying equipment, when activated, to determine a location in 3D space of the target.

2. The remote device of claim 1, wherein the target is configured to reflect a beam of light from the piece of surveying equipment, when activated, back toward the automated total station.

3. The remote device of claim 1, wherein the target comprises a pattern that can be recognised by the surveying equipment, when activated, in a 3D point cloud.

4. A surveying system for monitoring a location of an object, the surveying system comprising:
the remote device of claim 1; and
a base station comprising:
a receiver for receiving the signal from the transmitter; and
a controller configured to activate the piece of surveying equipment in response to receiving the signal.

5. A surveying system according to claim 4, further comprising the piece of surveying equipment.

6. The surveying system according to claim 5, wherein the piece of surveying equipment is configured to project a beam of light therefrom in response to being activated by the controller.

7. The surveying system according to claim 4, further comprising a plurality of the remote devices.

8. The surveying system according to claim 4, wherein the piece of surveying equipment comprises an automated total station, a 3D laser scanner, and/or a photogrammetry system.

9. A method of monitoring a location of an object, the method comprising the steps of:
providing the surveying system according to claim 4;
the sensor determining a movement of the remote device;
the transmitter sending a signal, in response to the movement of the remote device, to the base station;
the receiver receiving the signal from the transmitter;
the controller activating the piece of surveying equipment in response to receiving the signal; and
the piece of surveying equipment determining a location of the remote device.

10. The method of claim 9, wherein determining a location of the remote device comprises the piece of surveying equipment projecting a beam of light therefrom.

11. The method according to claim 10, wherein the piece of the piece of surveying equipment comprises an automated total station, and the method further comprising the step of the target reflecting the beam of light back toward the automated total station.

12. The method according to claim 10, wherein the piece of surveying equipment comprises a 3D laser scanner, and the step of determining the location of the remote device comprises processing 3D point cloud data acquired by the 3D laser scanner.

13. The method according to claim 9, wherein the piece of surveying equipment comprises a photogrammetry system, and the step of determining the location of the remote device comprises processing 3D point cloud data acquired by the photogrammetry system.
